(19) United States
(12) Patent Application Publication
(10) Pub. No.: US 2013/0044865 A1
(43) Pub. Date: Feb. 21, 2013

(54) RADIATION DOSE INFORMATION SHARING DEVICE AND METHOD

(71) Applicant: Takeshi KUWABARA, Ashigarakami-gun (JP)

(72) Inventor: Takeshi KUWABARA, Ashigarakami-gun (JP)

(73) Assignee: FUJIFILM CORPORATION, Tokyo (JP)

(21) Appl. No.: 13/562,477

(22) Filed: Jul. 31, 2012

(30) Foreign Application Priority Data
Aug. 16, 2011 (JP) 2011-177869

(51) Int. Cl. H05G 1/64

(52) U.S. Cl. 378/98

(57) ABSTRACT

Upon a request for sharing radiation dose information, a hospital A transmits first specification data of a first X-ray imaging system to a hospital B. The first specification data is written to a storage device of the hospital B. The storage device stores absorption data and second specification data, besides the first specification data. A storing and retrieving processing unit outputs the first and second specification data to an arithmetic section. Also, the storing and retrieving processing unit retrieves absorptance corresponding to the type of used intermediate member from the absorptance data, and sends a retrieval result to the arithmetic section. The arithmetic section converts a first optimal dose used in the first X-ray imaging system into a second optimal dose suitable for specifications of a second X-ray imaging system, based on data transmitted from the storing and retrieving processing unit.

### BACKGROUND OF THE INVENTION

1. Field of the Invention

The present invention relates to a radiation dose information sharing device and method for sharing information about an optimal radiation dose between a plurality of radiation imaging systems.

2. Description Related to the Prior Art

In medical diagnosis and treatment, a radiation imaging system, for example, an X-ray imaging system is widely known. The X-ray imaging system is constituted of an X-ray source for emitting X-rays to a patient's body and an electronic cassette for detecting an X-ray image of the body. The electronic cassette is composed of a flat panel detector (FPD) and a flat rectangular housing containing the FPD. The FPD has a matrix of pixels each of which accumulates signal charge by an amount corresponding to the amount of the X-rays incident thereon. The FPD accumulates the signal charge on a pixel-by-pixel basis, and converts the accumulated signal charge into a voltage signal in its signal processing circuit. Thereby, the FPD electrically detects the X-ray image, and outputs the X-ray image as digital image data. The FPD has X-ray sensitivity much higher than that of an X-ray film and an imaging plate (IP). This allows the FPD to obtain the high-quality X-ray image with a low radiation dose.

The electronic cassette is mounted not only on a specific imaging support, but also on an existing imaging support shareable between a film cassette and an IP cassette. Furthermore, the electronic cassette can be used while being put on a bed or held by the patient himself/herself, to take a radiograph of a body part that is hard to take with a stationary detector. The electronic cassette is sometimes brought out from a hospital for use in bedside radiography of a home-care patient or in an outside accident or natural disaster site in an emergency.

Conventionally, many techniques are proposed to reduce a radiation dose to be applied to the patient. For example, according to Japanese Patent Laid-Open Publication No. 2010-179155, a moving image capturing condition is determined such that the sum total of radiation doses applied during capturing a moving image becomes equal to or less than a radiation dose required for capturing a single static image.

By the way, in a case where a hospital is prepared with a plurality of X-ray imaging systems having different specifications, image quality variations, especially graininess variations among the X-ray images ascribed to the difference between the systems interfere with smooth and accurate diagnosis. For this reason, with the aim of making the image quality uniform, it is preferable to draw up guidelines for optimal doses on the basis of a body part to be imaged, an imaging direction, an imaging position, and the like, and share the guidelines among the plurality of systems. Drawing up the guidelines requires a number of radiography experiences in past, and is difficult for a small hospital having a limited number of patients. Therefore, the small hospital preferably uses the guidelines that a large hospital has drawn up.

However, various problems arise, if the guidelines that have been drawn up based on the X-ray images captured by a sample X-ray imaging system are applied as-is to another type of X-ray imaging system having different specifications. The X-ray sensitivity of the electronic cassette differs from maker to maker and from type to type. Even if the same dose of X-rays is applied, the image quality of the obtained X-ray image varies depending on the sensitivity of the electronic cassette. Furthermore, in the case of overlaying an intermediate member such as a grid on the electronic cassette, the grid absorbs the X-rays by specific absorptance. Accordingly, it is necessary to optimize the guidelines on a system-by-system basis.

By the optimization of the guidelines, a radiation dose to be applied can be sometimes set lower than an original dose set in the sample system. This is not limited to the case of sharing the guidelines of the optimal radiation doses among the plurality of X-ray imaging systems, but the same goes for the case of exchanging a part of the X-ray imaging system because of the deterioration or breakage of the part.

### SUMMARY OF THE INVENTION

An object of the present invention is to provide a radiation dose information sharing device that can easily share information about an optimal radiation dose between radiation imaging systems having different specifications, and a method thereof.

To achieve the above and other objects of the present invention, a radiation dose information sharing device according to the present invention includes a data acquisition section, a storage section, and an arithmetic section. The data acquisition section acquires first specification data of a first radiation imaging system and second specification data of a second radiation imaging system. The storage section stores the first and second specification data acquired by the data acquisition section. The arithmetic section converts a first optimal dose into a second optimal dose suitable for the second radiation imaging system based on the first and second specification data read out from the storage section. The first optimal dose is contained in the first specification data or calculated from the first specification data.

It is preferable that the radiation dose information sharing device further includes a display section for displaying a conversion result of the arithmetic section. The first and second specification data preferably includes at least one of items of sensitivity of a detection panel, a distance between a radiation source and an imaging plane, and the type of an intermediate member disposed between the radiation source and the imaging plane. The first optimal dose preferably varies from one imaging condition to another.

The storage section preferably stores absorptance data that represents absorptance of the radiation by the intermediate member. The arithmetic section preferably calculates an increase/decrease ratio of a radiation dose on the basis of the item of the first and second specification data read out from the storage section according a change from the first radiation imaging system to the second radiation imaging system, and calculates a total ratio being a product of the increase/decrease ratios of all the items, to obtain the second optimal dose by multiplying the first optimal dose by the total ratio. The absorptance data preferably includes the absorptance of the radiation by the intermediate member, and the absorptance is measured independently from one imaging condition to another.

The intermediate member preferably includes at least one of a grid for removing scattered radiation, an AEC sensor for automatic exposure control, a detection panel holder provided in an imaging support, a mattress put on the imaging support, and an additional filter provided in the radiation source.

The storage section may store tables each for representing a relation between a setup condition of the radiation source and an output radiation dose, independently from one type of radiation source to another. The second specification data may include the type of second radiation source used in the second radiation imaging system. The arithmetic section may output the setup condition of the second radiation source to obtain the second optimal dose by reference to the table that corresponds to the type of second radiation source. The first specification data may include the type of first radiation source used in the first radiation imaging system and an optimal setup condition of the first radiation source. The arithmetic section retrieves an output radiation dose that corresponds to the optimal setup condition as the first optimal dose from the table that corresponds to the type of first radiation source.

The arithmetic section may calculate the second optimal dose of each imaging condition in advance. The storage section may store the second optimal doses. Upon input of the imaging condition, the second optimal dose corresponding to the inputted imaging condition may be read out from the storage section. In another case, whenever an imaging condition is inputted, the arithmetic section may calculate the second optimal dose that corresponds to the imaging condition.

If a specification of a tube voltage of the radiation source is different between the first and second radiation imaging systems, the arithmetic section may calculate the second optimal dose based on the absorptance data of the intermediate member corresponding to the tube voltage, and correct a tube current or a radiation irradiation duration of the radiation source of the second radiation imaging system based on the ratio between the radiation dose of the first radiation imaging system and that of the second radiation imaging system in a state of having the same tube current-time product value.

The radiation dose information sharing device may further include a day counter for counting elapsed days from calibration of the radiation source of the second radiation imaging system and operation days of the detection panel of the second radiation imaging system. The storage section may store deterioration correction data that represents the relation of a dose correction rate of the radiation source relative to the number of the elapsed days and the relation of a dose correction rate relative to the number of the operation days. The arithmetic section may correct the second optimal dose based on the deterioration correction data read out from the storage section.

The data acquisition section may include a GUI displayed on the display section, for accepting entry of the first and second specification data, and an input device for entering the first and second specification data through the GUI.

The data acquisition section may be at least one of a network interface for receiving the first and second specification data transmitted over a network and a medium interface for importing the first and second specification data from a removable medium.

The radiation dose information sharing device may be provided in a console of the second radiation imaging system. In another case, the radiation dose information sharing device may be independent from both the first and second radiation imaging systems. In this case, the radiation dose information sharing device may further include a receiving section for receiving a sharing request from the second radiation imaging system, and a sending section for sending the second optimal dose calculated by the arithmetic section to the second radiation imaging system.

A radiation dose information sharing method includes the steps of acquiring first specification data of the first radiation imaging system and second specification data of the second radiation imaging system; storing the first and second specification data to a storage section; and reading out the first and second specification data from the storage section, and converting a first optimal dose into a second optimal dose suitable for the second radiation imaging system based on the first and second specification data. The first optimal dose is contained in the first specification data or calculated from the first specification data.

According to the present invention, the first optimal dose set up by the first radiation imaging system is converted into the second optimal dose to be used in the second radiation imaging system based on the first and second specification data of the first and second radiation imaging systems. Therefore, it is possible to easily share radiation dose information between the first and second radiation imaging systems having different specifications.

### BRIEF DESCRIPTION OF THE DRAWINGS

For more complete understanding of the present invention, and the advantage thereof, reference is now made to the following descriptions taken in conjunction with the accompanying drawings, in which:

FIG. 1 is a schematic view showing the structure of a first X-ray imaging system installed in a hospital A and a second X-ray imaging system installed in a hospital B;

FIG. 2 is a block diagram of a console;

FIG. 3 is an explanatory view of first specification data;

FIG. 4 is a block diagram showing the function of the console of the second X-ray imaging system in the hospital B and an information flow;

FIG. 5 is an explanatory view of absorptance data;

FIG. 6 is an explanatory view of a data entry window;

FIG. 7 is an explanatory view showing the contents of conversion processing of an arithmetic section;

FIG. 8 is an explanatory view of a conversion result display window;

FIG. 9 is a flowchart showing an operation flow from obtainment of the first specification data to display of a conversion result;

FIG. 10 is a block diagram showing the function of a console of a second embodiment having a day counter and deterioration correction data and an information flow; and

FIG. 11 is an explanatory view of conversion processing of an optimal dose according to a third embodiment in which the specifications of tube voltage differs between the first and second X-ray imaging systems.

### DESCRIPTION OF THE PREFERRED EMBODIMENTS

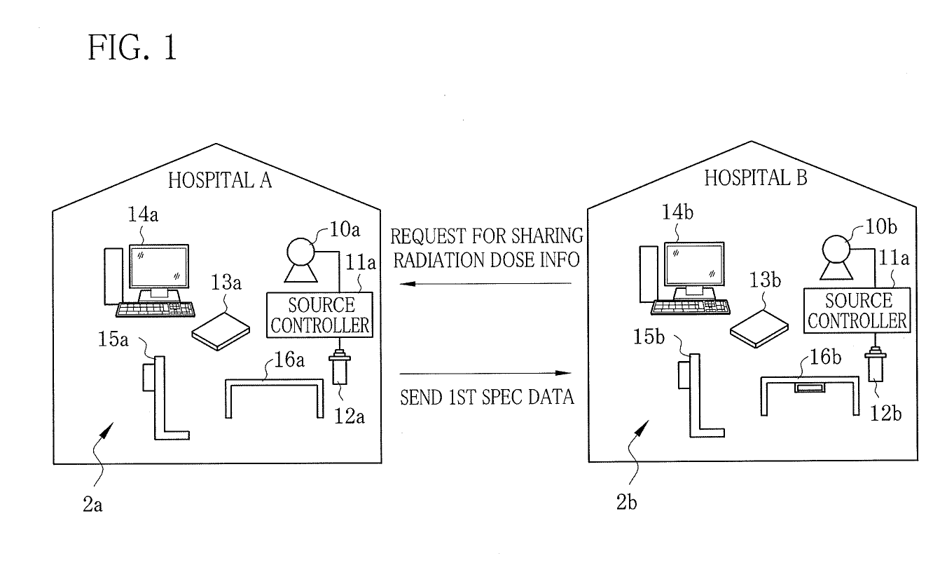

As shown in FIG. 1, a first X-ray imaging system 2a is installed in a hospital A, and a second X-ray imaging system 2b is installed in a hospital B. The first and second X-ray imaging systems 2a and 2b have different specifications from each other, while have almost the same basic configuration. Hereafter, the first X-ray imaging system 2a of the hospital A is described. As for the second X-ray imaging system 2b, components similar to those of the first X-ray imaging system 2a are indicated with the same reference numerals but with a suffix “b” instead of “a”, and the description thereof is omitted.

The X-ray imaging system 2a is constituted of an X-ray source 10a, a source controller 11a, an exposure switch 12a, an electronic cassette 13a, a console 14a, an imaging stand 15a, and an imaging table 16a. The X-ray source 10a contains an X-ray tube for emitting X-rays. The source controller 11a controls the operation of the X-ray source 10a. The exposure switch 12a commands the start of X-ray emission. The electronic cassette 13a detects an X-ray image based on the X-rays passed through a patient's body. The console 14a performs the operation control of the electronic cassette 13a and image processing of the X-ray image. The imaging stand 15a is used for taking a radiograph of the patient in a standing position. The imaging table 16a is used for taking a radiograph of the patient in a lying position. Additionally, the first X-ray imaging system 2a is provided with a source moving unit (not shown) for setting the X-ray source 10a in a desired direction and position.

As is widely known, the X-ray source 10a has the X-ray tube for emitting the X-rays, and a collimator for limiting an irradiation field of the X-rays. The X-ray tube has a cathode being a filament for emitting thermoelectrons, and an anode (target) for radiating the X-rays by collision of the thermoelectrons emitted from the cathode. The collimator is composed of four X-ray shielding lead plates disposed on each side of a rectangle so as to form an irradiation opening in its middle through which the X-rays propagate. Changing the positions of the lead plates can vary the size of the irradiation opening to limit the irradiation field.

The source controller 11a includes a high voltage generator and a controller. The high voltage generator supplies high voltage to the X-ray source 10a. The controller controls a tube voltage for determining an energy spectrum of the X-rays from the X-ray source 10a, a tube current for determining an X-ray irradiation amount per unit of time, and an X-ray irradiation duration. The high voltage generator produces the high tube voltage by multiplying an input voltage using a transformer, and supplies drive power to the X-ray source 10a through a high voltage cable. An imaging condition including the tube voltage, the tube current, and the X-ray irradiation duration is set up manually by a radiographic technician from an operation panel of the source controller 11a or from the console 14a through a communication cable.

The exposure switch 12a is a two-step switch operated by the radiographic technician. Upon a half press of the exposure switch 12a, a warm-up start signal is issued to start warming up the X-ray source 10a. Upon a full press of the exposure switch 12a, an irradiation start signal is issued to make the X-ray source 10a start emitting the X-rays. These signals are inputted to the source controller 11a through a signal cable.

The source controller 11a controls the operation of the X-ray source 10a based on the signals from the exposure switch 12a. Upon reception of the irradiation start signal from the exposure switch 12a, the source controller 11a starts supplying electric power to the X-ray source 10a, and, at the same time, actuates a timer to start measuring the X-ray irradiation duration. After a lapse of the predetermined X-ray irradiation duration set up by the imaging condition, the source controller 11a stops application of the X-rays. In taking a static image, a maximum X-ray irradiation duration is set at the order of approximately 500 msec to 3 sec.

As is widely known, the electronic cassette 13a includes a flat panel detector (FPD) and a portable housing containing the FPD. The FPD is of a TFT type based on amorphous silicon or a CMOS type based on single crystal silicon. The FPD has a matrix of pixels each of which accumulates signal charge by an amount corresponding to the amount of X-rays incident thereon. There are two types of FPDs, that is, a direct conversion type for directly converting the X-rays into the signal charge, and an indirect conversion type for converting visible light produced in a scintillator into the signal charge. The FPD accumulates the signal charge on a pixel-by-pixel basis, and converts the accumulated signal charge into a voltage signal at its signal processing circuit. Thereby, the FPD electrically detects the X-ray image, and outputs the X-ray image as digital image data.

The housing of the electronic cassette 13a is in a rectangular and flat box shape and approximately the same size as those of a film cassette and an IP cassette (also called CR cassette). In other words, the electronic cassette 13a is compatible with International Standard ISO4090:2001 in size and shape. Thus, the electronic cassette 13a can be set in an existing imaging support shareable between the film cassette and the IP cassette. A plurality of electronic cassettes 13a are provided in each examination room, for example, one electronic cassette 13a for each of the imaging stand 15a and the imaging table 16a. The electronic cassette 13a is detachably set on the imaging stand 15a or the imaging table 16a in a position such that an imaging plane of the FPD is opposed to the X-ray source 10a. In addition, the electronic cassette 13a is sometimes used separately from the imaging stand 15a or the imaging table 16a in a state of being put on a bed under the patient's body or held by the patient himself/herself.

The electronic cassette 13a is of a wireless type, for example, and establishes wireless communication with the console 14a using a radio wave or infrared light, besides wired communication using a communication cable. The electronic cassette 13a is energized not only from utility power through a power cable, but also from an internal battery.

The console 14a is connected to the electronic cassette 13a by a wired or wireless method in a communicatable manner, to control the operation of the electronic cassette 13a. To be more specific, the console 14a sends the imaging condition to the electronic cassette 13a to set up a signal processing condition of the FPD (including gain of an amplifier for amplifying voltage that corresponds to the accumulated signal charge). The console 14a also performs synchronization control to synchronize accumulation and readout operation of the FPD with irradiation start and end timing of the X-ray source 10a. Furthermore, the console 14a controls turn-on and -off of the electronic cassette 13a, and puts the electronic cassette 13a into a power saving mode and a preparation mode.

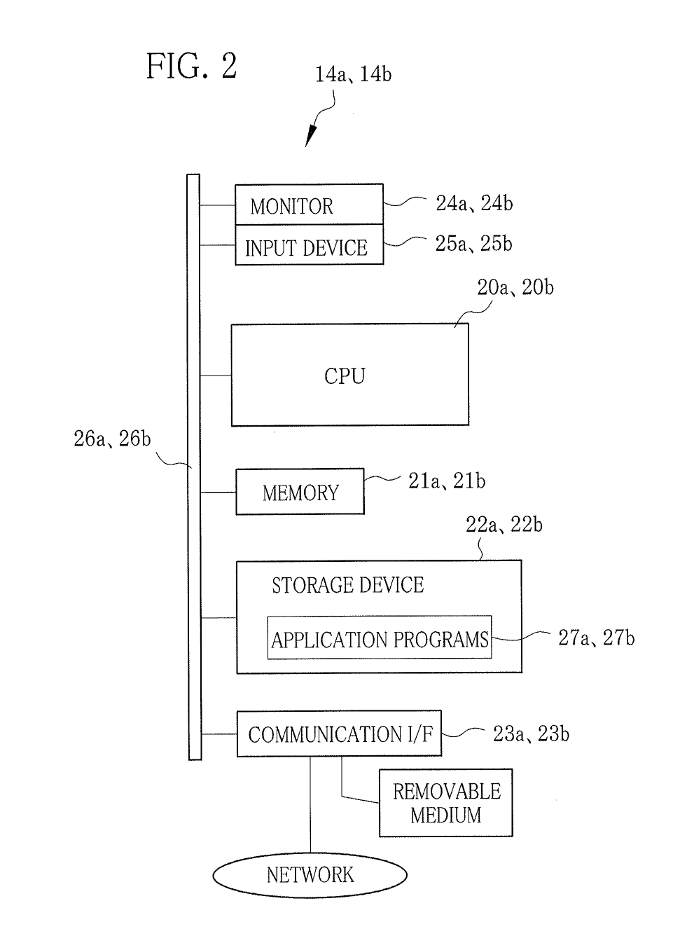

The console 14a applies various types of image processing such as an offset correction and a gain correction to X-ray image data sent from the electronic cassette 13a. The X-ray image after the image processing is displayed on a monitor 24a (see FIG. 2) of the console 14a. The X-ray image data after the image processing is written to a storage device 22a and a memory 21a (see FIG. 2) in the console 14a, or data storage such as an image server connected to the console 14a through a network.

To the console 14a, an examination order including information about sex and age of the patient, a body part to be imaged, an examination purpose, and the like is inputted from an input device 25a such as a keyboard. The examination order is displayed on the monitor 24a. The examination order is inputted from an external system e.g. HIS (hospital information system) or RIS (radiography information system) that manages patient data and examination data related to radiography, or inputted manually by the radiographic technician. The examination order includes the body part to be examined e.g. head, chest, abdomen, and the like, and an imaging direction e.g. anterior, medial, diagonal, PA (X-rays are applied from a posterior direction), and AP (X-rays are applied from an anterior direction). The radiographic technician confirms the contents of the examination order on the monitor 24a, and inputs the imaging condition corresponding to the contents of the examination order from the input device 25a through an operation screen displayed on the monitor 24a.

As shown in FIG. 2, the console 14a is composed of a computer having a CPU 20a, the memory 21a, the storage device 22a, a communication I/F 23a, the monitor 24a, and the input device 25a. These components are connected to each other via a data bus 26a. Note that, FIG. 2 has reference numerals of the console 14b of the second X-ray imaging system 2b, in addition to reference numerals of the console 14a of the first X-ray imaging system 2a.

The storage device 22a is a hard disk drive (HDD), for example. The storage device 22a stores control programs and application programs 27a. Running the application programs 27a makes the console 14a perform various functions related to radiography, such as display processing of the examination order and the X-ray image, image processing of the X-ray image, and setup of the imaging condition.

The memory 21a is a work memory used when the CPU 20a performs processing. The CPU 20a loads the control programs stored on the storage device 22a into the memory 21a, and runs the programs for centralized control of the computer. The communication I/F 23a functions as both a network interface and a medium interface for performing transmission control from/to an external device such as the RIS, the HIS, the image server, and the electronic cassette 13a, and an external storage medium such as a removable medium. The input device 25a includes a keyboard and a mouse, or a touch panel integrated with the monitor 24a.

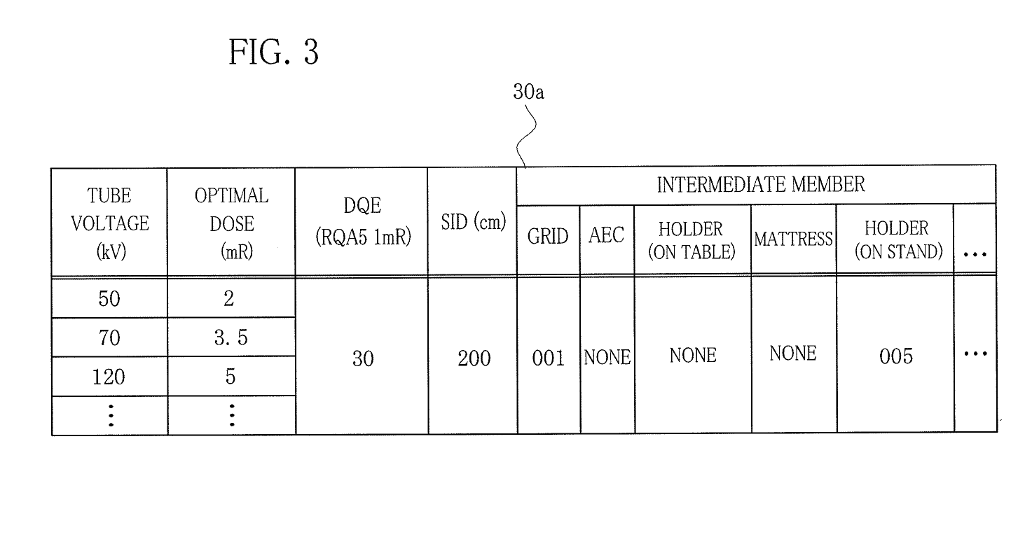

The hospital A, being a large hospital of this community area, performs a model radiation dose control. The hospital B, being an affiliated or partnership hospital of the hospital A, makes a request for sharing radiation dose information to the hospital A in order to import the model radiation dose control. In response to the request from the hospital B, the hospital A transmits specification data of the first X-ray imaging system 2a, i.e. first specification data 30a (see FIG. 3) to the hospital B. The hospital B optimizes the radiation dose control of the second X-ray imaging system 2b based on the first specification data 30a.

As shown in FIG. 3, the first specification data 30a includes items of a tube voltage (kV) of the X-ray source 10a and an optimal dose i.e. a first optimal dose (mR) at each tube voltage. The values of the tube voltage and the first optimal dose vary depending on the body part to be imaged. The optimal dose is an appropriate value of a radiation dose to be applied to the body part by which the first X-ray imaging system 2a can obtain the high-quality X-ray image adequate for diagnosis without excessive exposure. A setup condition (tube current-time product, mAs) of the X-ray source 10a to produce the first optimal dose is derived from practical experience or obtained using a dosimeter. For example, in the case of a tube voltage of 80 kV, a source-to-image distance (SID) between the X-ray source 10a and the imaging plane of the FPD of 180 cm, and a first optimal dose of 10 mR, the tube current-time product is set at 6.4 mAs. Note that, the first optimal dose may be set more precisely in accordance with the physique of the patient e.g. thin, fat, and the like.

The first specification data 30a also includes an item of detective quantum efficiency (DQE) of the FPD of the electronic cassette 13a relative to 1 mR of X-rays of radiation quality RQA5 defined by IEC61267, an item of the SID, and an item of the type (ID) of intermediate members.

In brief, the DQE indicates sensitivity of the FPD to the X-rays or the visible light produced by the scintillator. The higher the DQE, the lower dose a radiograph requires. The intermediate member is disposed between the X-ray source 10a and the imaging plane of the FPD, and reduces the amount of the X-rays to be incident upon the FPD. The intermediate member includes a grid for removing the X-rays scattered by the patient's body, an AEC sensor for automatic exposure control by which a dose of the X-rays passed through the patient's body is detected to stop X-ray irradiation when the dose reaches a predetermined value, a holder for holding the electronic cassette 13a on the imaging table 16a or the imaging stand 15a, a mattress put on the imaging table 16a, and the like. The intermediate member may further include a filter disposed in the X-ray source 10a for the purpose of changing the radiation quality of the X-rays by cutting a lower energy component of the X-rays. Note that, the grid is attached to the front of the electronic cassette 13a.

In this embodiment, the first optimal dose is 2, 3.5, and mR at tube voltages of 50, 70, and 120 kV, respectively. The DQE is 30, and the SID is 200 cm. As for the intermediate members, a grid having an ID number “001” and a holder on the imaging stand 15a having an ID number “005” are used. Since the AEC sensor is unused, “none” is entered. The imaging table 16a has no holder and the patient lies directly over the electronic cassette 13a put on a mattress of the imaging table 16a, so “none” is entered into a holder (on table) field and a mattress field. Note that, if the AEC sensor is disposed not on a front surface of the FPD but on a back surface thereof, or the AEC sensor is out of an imaging field of the FPD, “none” is entered in an AEC sensor field because the AEC sensor does not affect an incident amount of the X-rays on the imaging plane of the FPD.

A staff member of the hospital A may transmit the first specification data 30a to a staff member of the hospital B by word of mouth over the phone, or send by mail a removable medium such as a CD-R on which the first specification data 30a is recorded. In another case, the first specification data 30a may be transmitted over a network on which both the hospitals A and B have access. In the case of transmitting the first specification data 30a on the removable medium or the network, the communication I/F 23b functions as a data acquisition section.

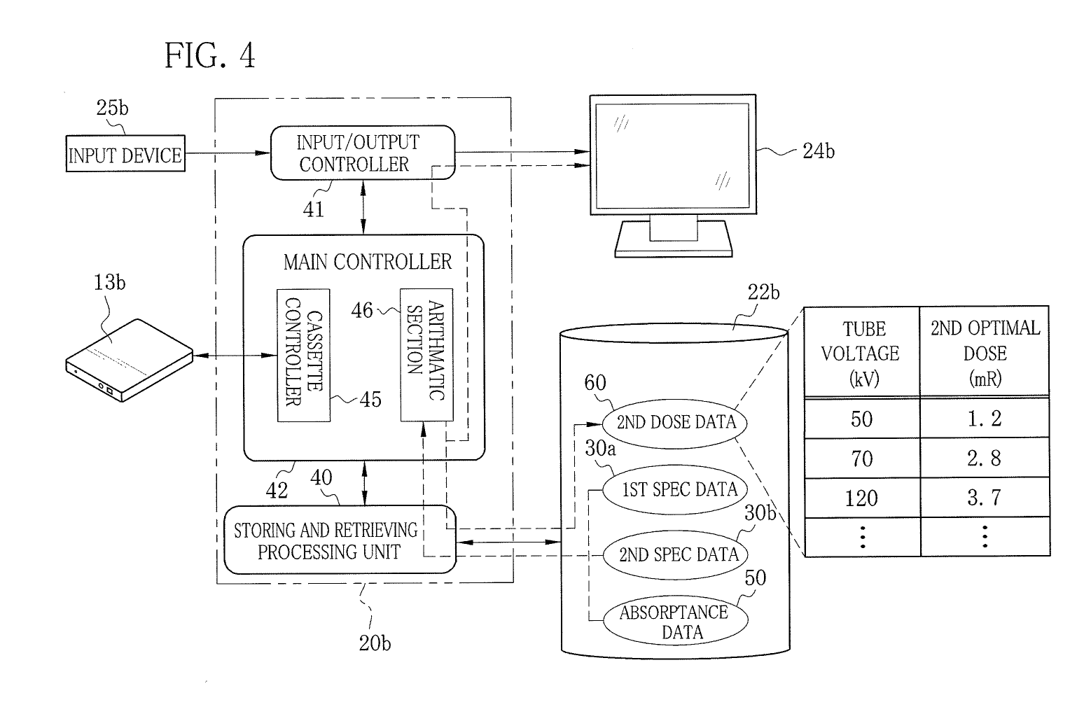

As shown in FIG. 4, by running the application programs 27b, the CPU 20b of the console 14b of the hospital B functions as a storing and retrieving processing unit 40, an input/output controller 41, and a main controller 42. The storing and retrieving processing unit 40 stores various types of data to the storage device 22b, and retrieves the data from the storage device 22b. The input/output controller 41 reads out drawing data from the storage device 22b in response to operation on the input device 25b, and outputs to the monitor 24b various operation screens of GUIs based on the read drawing data. The input/output controller 41 receives input of operation commands from the input device 25a through the operation screens. The main controller 42 includes a cassette controller 45, which controls the operation of the electronic cassette 13a, and an arithmetic section 46. The main controller 42 performs centralized control of the console 14b.

The first specification data 30a sent from the hospital A is entered into the console 14b of the hospital B manually from the input device 25b or automatically through the removable medium or the network. The storing and retrieving processing unit 40 writes the first specification data 30a to the storage device 22b.

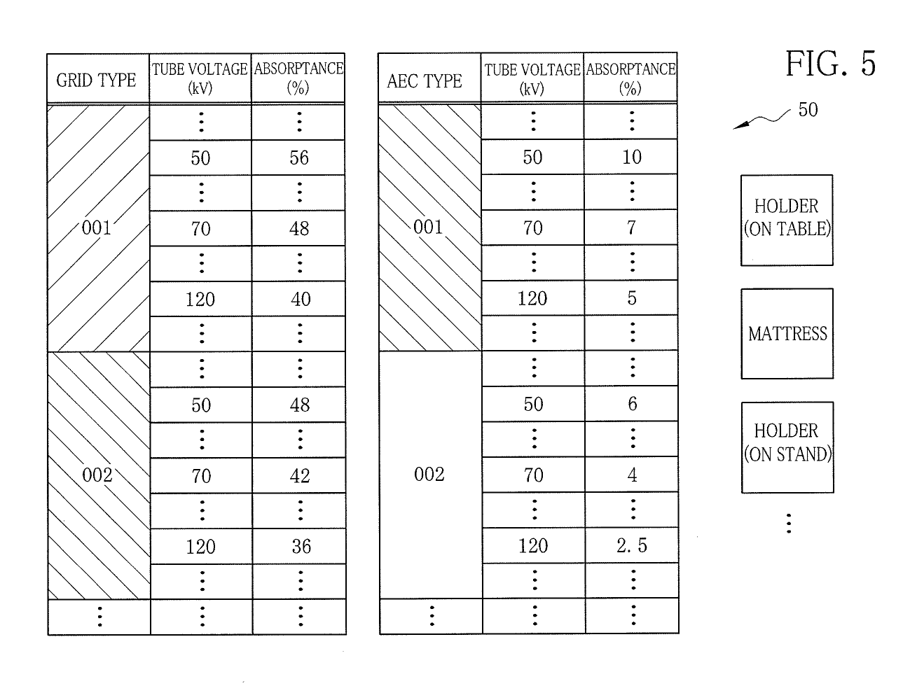

The first storage device 22b stores absorptance data 50 and second specification data 30b, in addition to the first specification data 30a. The absorptance data 50, as shown in FIG. 5, includes the type (ID) of the intermediate members including the grids and the AEC sensors, and X-ray absorptance of each type of intermediate members with respect to the tube voltage (only the grids and the AEC sensors are drawn in FIG. 5). For example, a grid of an ID number “001” has an absorptance of 40% at a tube voltage of 120 kV, an absorptance of 48% at a tube voltage of 70 kV, and an absorptance of 56% at a tube voltage of 50 kV. The absorptance data 50 is stored in advance on the storage device 22b at the time of shipping of the second X-ray imaging system 2b (console 14b). Whenever a manufacturer of the second X-ray imaging system 2b (console 14b) releases a new product of the intermediate member, latest absorptance data is distributed over the network or the like to update the absorptance data 50 at any time. Instead of the automatic update, the latest absorptance data of the intermediate members usable in the system 2b may be obtained from the manufacturer and inputted manually from the input device 25b.

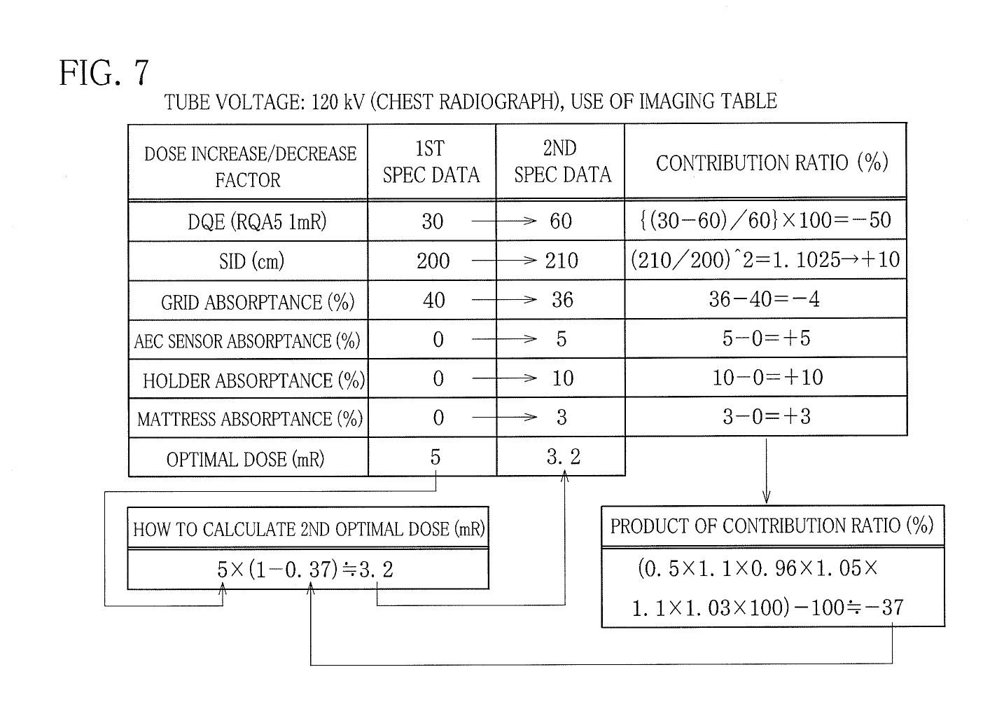

The second specification data 30b, which is specification data of the second imaging system 2b of the hospital B, corresponds to the first specification data 30a of the first X-ray imaging system 2a of the hospital A. The second specification data 30b has the same items as those of the first specification data 30a, but has different values according to the difference in the specifications between the first and second imaging systems 2a and 2b (see FIG. 7).

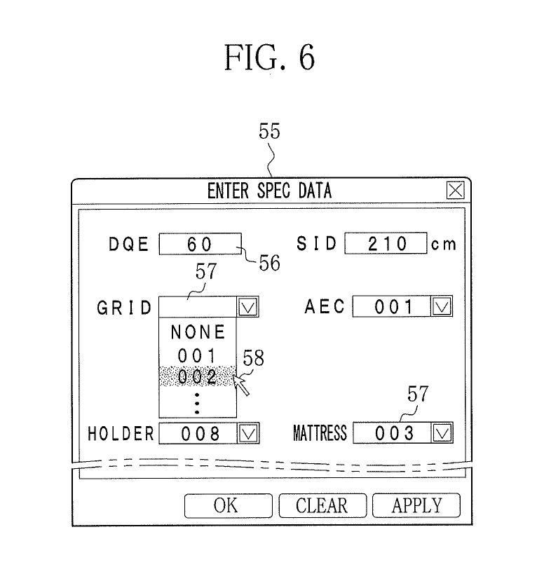

When the hospital B accepts the radiation dose information of the hospital A, the input/output controller 41 displays a data entry window 55 of FIG. 6 on the monitor 24b. The data entry window 55 has entry boxes 56 into which values of the DQE and the SID are entered, and pull-down menus 57 for choosing the ID (including “none”) of the intermediate members.

In this embodiment, “60” and “210” are entered in the DQE and SID boxes, respectively. “001” is chosen as the ID of the AEC sensor. “008” is chosen as the ID of the holder (on the imaging table). “003” is chosen as the ID of the mattress. In FIG. 6, “002” is chosen as the ID of the grid, with a click on the pull-down menu 57 using a pointer 58 of the mouse.

FIG. 7 represents the first and second specification data 30a and 30b in a comparable manner. The DQE of the second imaging system 2b is twice as large as that of the first imaging system 2a. This indicates that the FPD of the electronic cassette 13b of the second imaging system 2b is superior in the X-ray or visible light sensitivity to the FPD of the first imaging system 2a. The SID of the second specification data 30b is 210 cm, while the SID of the first specification data 30a is 200 cm. This indicates that the imaging plane of the FPD of the electronic cassette 13b is another 10 cm away from the X-ray source 10b due to the addition of the AEC sensor, the holder on the imaging table 16b, and the mattress. Although the distance from the X-ray source 10a, 10b to the patient's body is the same between the first and second imaging systems 2a and 2b, the disposition of the AEC sensor, the holder, and the mattress between the body and the imaging plane of the FPD makes the imaging plane away from the X-ray source 10b by the thicknesses of the AEC sensor, the holder, and the mattress.

After the required items are entered into the data entry window 55, an OK or apply button is clicked, so the storing and retrieving processing unit 40 writes to the storage device 22b the second specification data 30b according to an entry state. Note that, the first specification data 30a may be entered manually on a similar data entry window.

The storing and retrieving processing unit 40 outputs to the arithmetic section 46 the DQE, the first optimal doses, and the SID from the first and second specification data 30a and 30b stored in the storage device 22b. Furthermore, the storing and retrieving processing unit 40 retrieves the absorptance corresponding to the type (ID) of the intermediate member from the absorptance data 50, and sends a retrieval result to the arithmetic section 46. In this embodiment, since the grid of the first specification data 30a has an ID number “001”, and the grid of the second specification data 30b has an ID number “002”, and the AEC sensor of the second specification data 30b has an ID number “001”, values corresponding to the grids of the ID numbers “001” and “002” and values corresponding to the AEC sensor of the ID number “001” are retrieved from the absorptance data 50 and sent, as shown in hatching in FIG. 5. In addition, the absorptance of the other intermediate members, that is, the holder (on the imaging table) having an ID number “008” and the mattress having an ID number “003” is transmitted to the arithmetic section 46.

The arithmetic section 46 converts the first optimal doses of the first imaging system 2a into values (second optimal doses) corresponding to the specifications of the second imaging system 2b, based on data transmitted from the storing and retrieving processing unit 40.

As a concrete example, a radiograph is taken at a tube voltage of 120 kV (chest radiograph) with the use of the imaging table 16b. Retrieving from tables of FIGS. 3 and 5, the first specification data 30a has a DQE of 30, an SID of 200 cm, a grid absorptance of 40%, no AEC sensor absorptance, no holder (on table) absorptance, no mattress absorptance, and a first optimal dose of 5 mR, as summarized in FIG. 7. On the other hand, the second specification data 30b has a DQE of 60, an SID of 210 cm, a grid absorptance of 36%, an AEC sensor absorptance of 5%, a holder (on table) absorptance of 10%, and a mattress absorptance of 3%. The DQE, the SID, and the absorptance of the intermediate members of the first and second specification data 30a and 30b are collectively called as a dose increase/decrease factor (abbreviated as factor).

The arithmetic section 46 calculates how much a dose increases or decreases by a change from the first X-ray imaging system 2a to the second X-ray imaging system 2b, in other words, a dose increase/decrease contribution ratio (abbreviated as contribution ratio) on an item-by-item basis of the factor. The contribution ratio C_{DQE} of the DQE is calculated as follows:

C_{DQE}={(DQE_{old}−DQE_{new})/DQE_{new}}×100

Wherein DQE_{old} represents the DQE of the first X-ray imaging system 2a, and DQE_{new} represents the DQE of the second X-ray imaging system 2b. In this embodiment, DQE_{old}=30 and DQE_{new}=60, so the DQE contribution ratio C_{DQE} is calculated as follows:

{(30−60)/60}×100=−50

A negative contribution ratio C indicates that the dose is decreasable by the change from the first X-ray imaging system 2a to the second X-ray imaging system 2b, while a positive contribution ratio C indicates that the dose is increased. In this embodiment, the DQE contribution ratio C_{DQE} is −50%, so the dose of the second X-ray imaging system 2b is reduced into half of that of the first X-ray imaging system 2a, only with regard to the DQE. The same goes for the other items of the factor.

The contribution ratio C_{SID} of the SID is calculated as follows:

C_{SID}={(SID_{new}/SID_{old})²−1}×100

Wherein SID_{old} represents the SID of the first X-ray imaging system 2a, and SID_{new} represents the SID of the second X-ray imaging system 2b. In this embodiment, SID_{old}=200 and SID_{new}=210, so the SID contribution ratio C_{SID} is calculated as follows:

{(210/200)²−1}×100=+10%

Note that, SID_{new}/SID_{old} is squared because the dose is inversely proportional to the square of the distance.

The contribution ratio C_{OB} of the intermediate member is calculated as follows:

C_{OB}=OB_{new}−OB_{old}

Wherein OB_{old} represents the absorptance of the intermediate member of the first X-ray imaging system 2a, and OB_{new} represents the absorptance of the intermediate member of the second X-ray imaging system 2b. “0” is substituted, when no intermediate member is used, as in the cases of the AEC sensor, the holder (on table), and the mattress of this embodiment. In this embodiment, the grid of the second X-ray imaging system 2b has a lower absorptance than that of the first X-ray imaging system 2a, so the contribution ratio of the grid becomes −4%, a negative value. The contribution ratios of the other items, i.e. the AEC sensor, the holder (on table), and the mattress become positive values, because these items are newly provided in the second X-ray imaging system 2b.

The arithmetic section 46 calculates the product Cₚᵣₒ of the contribution ratios C of the individual items. This value Cₚᵣₒ indicates that how much the first optimal dose is increased or decreased to be applied to the second X-ray imaging system 2b. As described above, if the Cₚᵣₒ is a negative value, the optimal dose is decreased. If the Cₚᵣₒ is a positive value, the optimal dose is increased. In this embodiment, the following expression holds.

Cₚᵣₒ=(0.5×1.1×0.96×1.05×1.1×1.03×100)−100≅−37%

Accordingly, the first optimal dose 5 mR is reduced by 37%. In short, the second optimal dose is 63% of 5 mR.

When P_{old} represents the first optimal dose, the second optimal dose P_{new} is calculated as follows:

P_{new}=P_{old}×{1+(Cₚᵣₒ/100)

In this embodiment, P_{old}=5 and Cₚᵣₒ=−37%, so the second optimal dose P_{new} is calculated as follows:

5×(1−0.37)≅3.2

Therefore, the first optimal dose 5 mR is reduced into the second optimal dose 3.2 mR.

The arithmetic section 46 calculates the second optimal dose of each tube voltage (on each imaging condition such as standing position or lying position) in this manner. The storing and retrieving processing unit 40 writes the calculation results of the second optimal doses to the storage device 22b as second dose data 60, as shown in FIG. 4. In the second dose data 60, the second optimal doses are stored on the basis of the tube voltage (imaging condition). The second optimal doses may be stored on the basis of the body part to be imaged, instead. Since the body partisan essential item the radiographic technician necessarily enters from the console 14b whenever radiography is performed, storing the second optimal doses on the basis of the body part and retrieving the second optimal dose in synchronization with the entry of the body part enhance convenience.

If the imaging condition such as the body part and the tube voltage is entered (one of the body part and the tube voltage is entered because the tube voltage almost depends on the body part) from the input device 25b of the console 14b prior to taking a radiograph with the second X-ray imaging system 2b, the storing and retrieving processing unit 40 retrieves the second optimal dose from the second dose data 60 in accordance with the inputted imaging condition, and sends a retrieval result to the input/output controller 41.

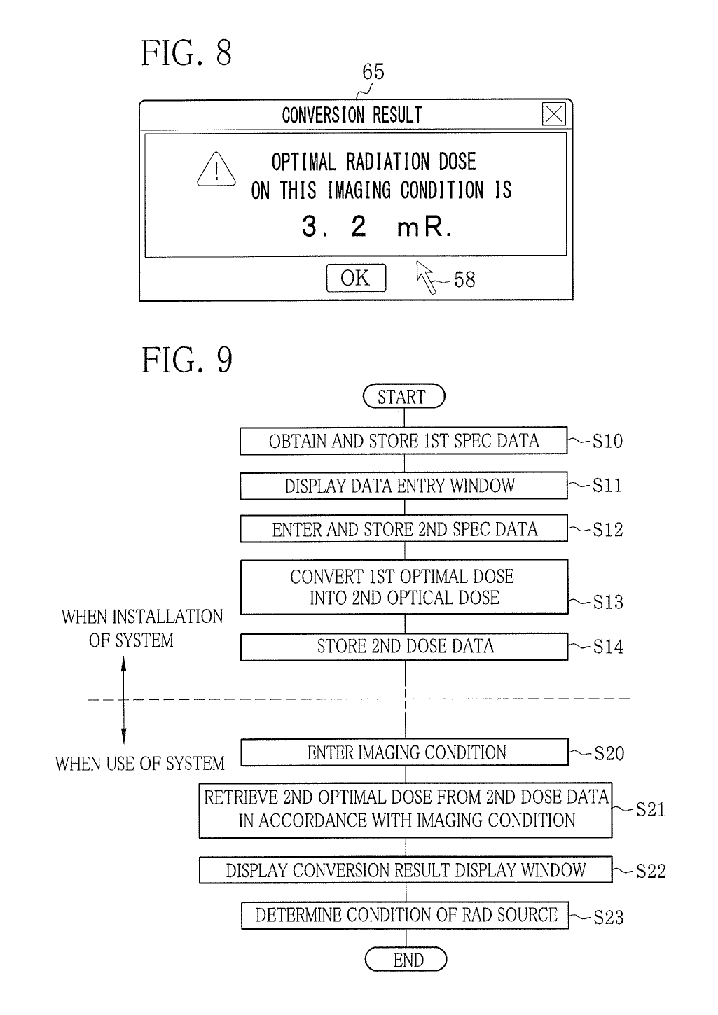

The input/output controller 41 displays on the monitor 24b a conversion result display window 65 that describes the second optimal dose as shown in FIG. 8, to inform the radiographic technician of the optimal dose suitable for the second X-ray imaging system 2b. The first optimal dose, the recommended tube voltage, and the recommended X-ray irradiation duration may be displayed together with the second optimal dose. The radiographic technician makes the setting of the imaging condition including the tube voltage and the X-ray irradiation duration from the input device 25b, such that radiography is performed with the second optimal dose seen in the conversion result display window 65. In another case, the imaging condition may be set up automatically by the main controller 42.

The operation of the above structure will be described with referring to a flowchart of FIG. 9. First in S10, the hospital B accepts the first specification data 30a of the first X-ray imaging system 2a from the hospital A at the console 14b of the second X-ray imaging system 2b, and the storing and retrieving processing unit 40 writes the first specification data 30a to the storage device 22b. Then, the data entry window 55 is displayed on the monitor 24b (S11), for the entry of the second specification data 30b of the second X-ray imaging system 2b. The second specification data 30b is written to the storage device 22b (S12).

The arithmetic section 46 converts the first optimal dose of each imaging condition into the second optimal dose based on the first and second specification data 30a and 30b and the absorptance data 50 stored in the storage device 22b (S13). Then, the conversion results are written to the storage device 22b as the second dose data 60 (S14).

When using the second X-ray imaging system 2b, upon the entry of the imaging condition such as the body part to be imaged or the tube voltage (S20), the storing and retrieving processing unit 40 retrieves from the second dose data 60 the second optimal dose corresponding to the imaging condition (S21). The retrieved second optimal dose is displayed on the conversion result display window 65 (S22). The imaging condition is determined such that radiography is performed with the optimal dose seen in the conversion result display window 65 (S23), and then the radiography is carried out.

According to the present invention, as described above, the first optimal dose is converted into the second optimal dose based on the obtained first and second specification data 30a and 30b and the absorptance data 50, and the conversion result is displayed. Therefore, it is possible to import the optimal dose of the first X-ray imaging system 2a to the second X-ray imaging system 2b with a relatively easy procedure, and equalize the image quality of the X-ray image between the first and second X-ray imaging systems 2a and 2b. If the second optimal dose is lower than the first optimal dose, radiation exposure is reduced. Also, in a case where the low-sensitive IP cassette is replaced with the high-sensitive electronic cassette, the second optimal dose becomes much lower than the first optimal dose. Thus, the present invention is effective at reducing the radiation exposure.

The absorptance data 50 of the various intermediate members facilitates precise calculation of the second optimal dose according to any change of the X-ray imaging system. The arithmetic section 46 calculates in advance the second optimal dose of each imaging condition before the radiography, and the second optimal doses are stored to the storage device 22b as the second dose data 60. Upon the entry of the imaging condition, the appropriate second optimal dose is read out from the second dose data 60. Accordingly, the radiographic technician is quickly informed of the second optimal dose after the entry of the imaging condition.

It is known that the intermediate member absorbs a low energy component of the X-rays more than a high energy component thereof, and biases the radiation quality of the X-rays so as to shift an energy peak to a high energy side (this phenomenon is called beam hardening). For this reason, if the number of the intermediate members is large, the absorptance should be calculated with correction of an energy spectrum in consideration of the beam hardening. However, the X-rays passed through the patient's body hardly contain the low energy component, and their spectra are closely analogous to those of the X-rays having only the high energy component. Thus, the optimal dose can be calculated without consideration of the beam hardening, just as with the above embodiment.

The intermediate member may be provided with a memory or a bar cord such as a RFID tag for storing its ID number. When the intermediate member is used in the X-ray imaging system, the ID number stored in the memory or the bar cord may be automatically read out to automate input of the specification data. In a like manner, input of the DQE and the SID may be automated through storing the DQE in the electronic cassette, provision of a device such as an optical sensor for automatic measurement of the SID, and the like. The automation saves time and trouble in displaying the data entry window 55 and manually inputting the specification data.

In the above embodiment, the arithmetic section 46 calculates in advance the second optimal dose of each imaging condition before the radiography, and the second optimal doses are stored to the storage device 22b as the second dose data 60. However, only input of the first and second specification data 30a and 30b is carried out before the radiography, and whenever the imaging condition is entered, the arithmetic section 46 may calculate the second optimal dose based on the imaging condition. This is suitable for a case where the size of the second dose data 60 becomes large to such an extent as to put a squeeze on the capacity of the storage device 22b due to the variety of the imaging conditions.

The hospital B shares the radiation dose information of the hospital A in the above embodiment, but the present invention is applicable to the case of changing specifications of an X-ray imaging system of a hospital (replacement of an electronic cassette or a grid, addition of an AEC sensor, and the like), the case of sharing an electronic cassette among a plurality of X-ray imaging systems in a hospital, and the like. Thus, the first and second X-ray imaging systems are not necessarily composed of separate systems, but may be substantially the same system, and more specifically may be a single system before and after changing one or more components. In short, if the present invention is applied to the case of changing the contribution ratio due to a change of the factor, the same effect as that of the above embodiment is obtained. Accordingly, a detection panel is not limited to the electronic cassette containing the FPD, but may be a film cassette, an IP cassette, or an imaging table/stand installation type of detection panel as long as its DQE is known. In this case, an ID number is allocated to each cassette, and the ID number and the optimal dose data calculated in advance may be managed in relation to each other separately from cassette to cassette having the different DQE. This facilitates quickly providing an optimal condition in response to a read of the ID number of the used cassette before taking radiography from a screen input, a bar code, an RFID tag, or the like, even in the case of using the different types of cassettes.

Other than the factors described in the above embodiment, there is aged deterioration of the X-ray source and the electronic cassette conceivable as a factor for changing the contribution ratio. Thus, the optimal dose is preferably calculated in consideration of the aged deterioration too.

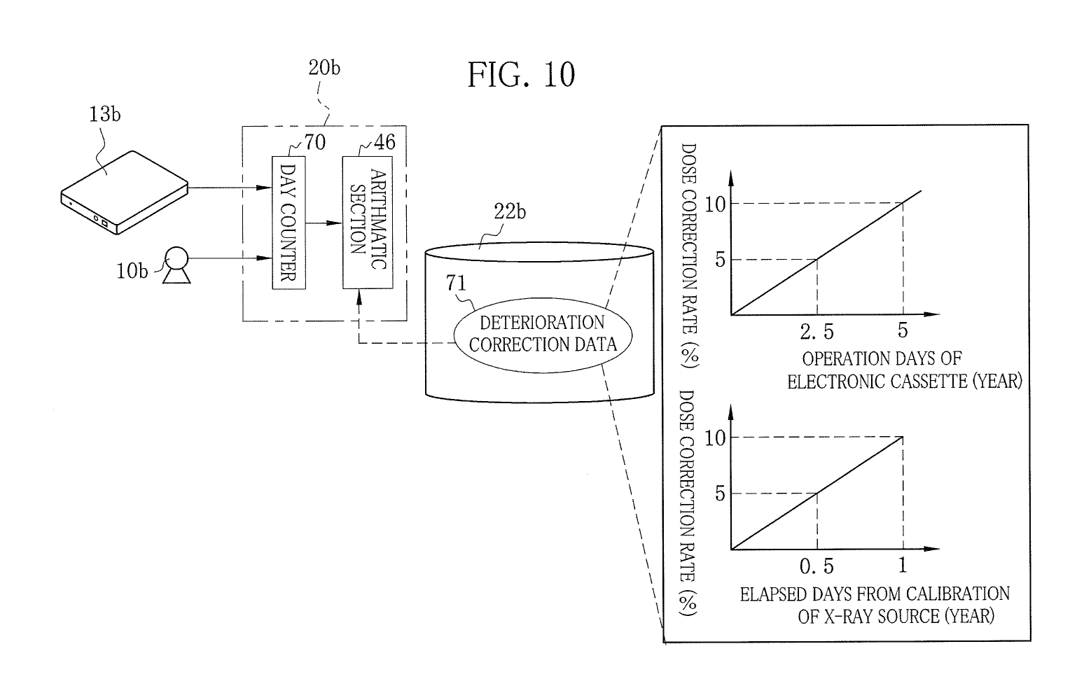

In this case, as shown in FIG. 10, the CPU 20b of the console 14b of the second X-ray imaging system 2b is provided with a day counter 70, and the storage device 22b stores deterioration correction data 71 in advance. In FIG. 10, components such as the storing and retrieving processing unit 40 and the input/output controller 41 and data such as the first and second specification data 30a and 30b are omitted. The day counter 70 counts operation days of the used electronic cassette 13b, and elapsed days from the latest calibration of the X-ray source 10b that removes an adverse effect on dose i.e. reduction of X-ray emission due to the aged deterioration. The day counter 70 outputs count data to the arithmetic section 46.

The deterioration correction data 71 represents the relation between a dose correction rate and the operation days of the electronic cassette 13b, and the relation between a dose correction rate and the elapsed days from the latest calibration of the X-ray source 10b in a data table or a functional form. The electronic cassette 13b and the X-ray source 10b are reduced in performance of X-ray detection and X-ray emission due to an extended period of use. Thus, in the deterioration correction data 71, the dose correction rate is increased with increase in the number of any of the operation days and the elapsed days. For example, the dose correction rate relative to the operation days of the electronic cassette 13b is 10% at five years of operation. The dose correction rate relative to the elapsed days from the calibration of the X-ray source 10b is 10% at one year of elapse. Adding the dose correction rate to the setup of the tube current or the X-ray irradiation duration can eliminate the deleterious effect of the aged deterioration, and carry out radiography without the deleterious effect. Note that, since the calibration of the X-ray source 10b is performed annually, the dose correction rate within one year of the elapsed days from the calibration of the X-ray source 10b is stored.

The arithmetic section 46 receives from the day counter 70 data of the operation days of the electronic cassette 13b and the elapsed days from the calibration of the X-ray source 10b. The arithmetic section 46 receives the dose correction rates corresponding to the numbers of the operation days and the elapsed days from the dose correction data 71 through the storing and retrieving processing unit 46, and adds the dose correction rates to the tube current or the X-ray irradiation duration corresponding to the second optimal dose. For example, in a case where the tube current corresponding to the second optimal dose is 100 mA, the number of operation days of the electronic cassette 13b is one year, and the calibration of the X-ray source 10b was performed six months ago (elapsed days of 0.5 year), the dose correction rate according to the number of operation days is 2%, and the dose correction rate according to the number of elapsed days is 5%. Therefore, the tube current to be actually applied to the X-ray source 10b is calculated as follows:

100×1.02×1.05=107.1

The same goes for the case of the X-ray irradiation duration, instead of the tube current. As described above, consideration of the aged deterioration, in addition to the specifications of the system, allows more accurate calculation of the optimal dose.

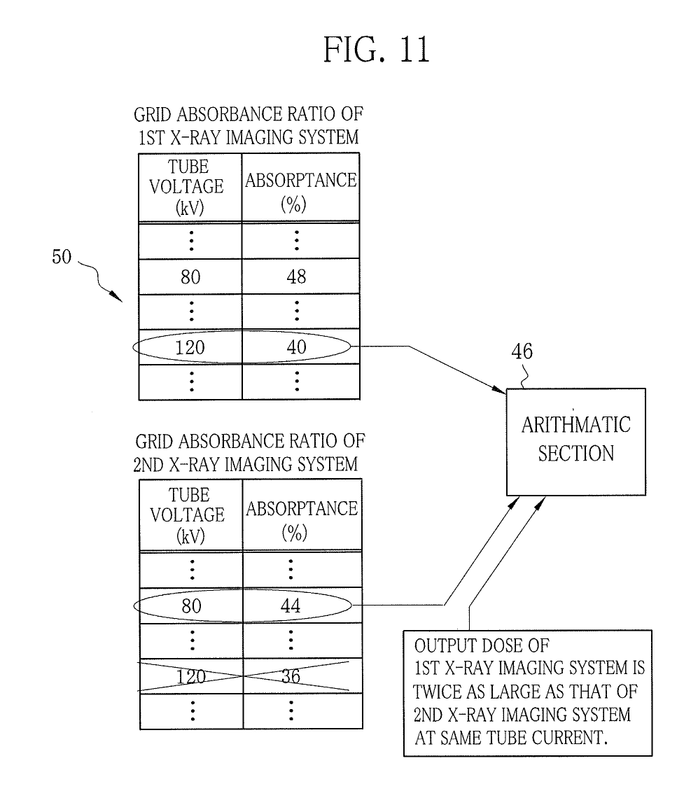

There is a case where the first and second imaging systems 2a and 2b have different output performance of the X-ray source. A case in which the tube voltage of the first X-ray imaging system 2a is 120 kV at the maximum, while that of the second X-ray imaging system 2b is 80 kV is taken as an example. In such a case, as shown in FIG. 11, the absorptance (44%) of the intermediate member e.g. the grid of the second imaging system 2b is retrieved from the absorptance data 50 referring to a row of a tube voltage of 80 kV. Using this absorptance 44% and the absorptance (40%) of the intermediate member of the first X-ray imaging system 2a, which is retrieved from a row of a tube voltage of 120 kV, the contribution ratio C_{OB} is calculated. The arithmetic section 46 calculates the second optimal dose based on the contribution ratio C_{OB}. After that, the tube current or the X-ray irradiation duration is determined based on the second optimal dose. On the condition that the first and second X-ray imaging systems 2a and 2b have the same tube current-time product (mAs) value, if the first X-ray imaging system 2a outputs an X-ray dose of 5 mR at a tube voltage of 120 kV, and the second X-ray imaging system 2b outputs an X-ray dose of 2.5 mR at a tube voltage of 80 kV, the tube current or the X-ray irradiation duration of the second X-ray imaging system 2b is increased twice as large as that of the first X-ray imaging system 2a in order to output the same X-ray dose.

In another case, the first X-ray imaging system 2a may supply another index such as an S value, an EI value, or a REX value, which is obtained from the X-ray image data by histogram analysis. The tube current or the X-ray irradiation duration may be adjusted so as to accommodate the index of the second X-ray imaging system 2b to the index of the first X-ray imaging system 2a.

The console 14b of the hospital B takes control of the electronic cassette 13b and the like, and a computer other than the console 14b may have the function of the above arithmetic section or storage for storing the absorptance data. An external agency other than the hospitals A and B, for example, a service center of a manufacturer of the electronic cassette may have a server that plays the same role as the above console 14b of the hospital B. In this case, a CPU of the server functions as the arithmetic section, and a storage device of the server stores the absorptance data. In another case, the server has only the function of the arithmetic section, and the absorptance data may be stored in the console of each system or another data server e.g. a data server of a manufacturer of the intermediate member in a retrievable manner over a network. In this case, the first and second specification data 30a and 30b is transmitted to the server. The server calculates the second optimal dose, and transmits the second optimal dose to the client hospital. If the server of the service center deals with the calculation of the optimal dose, it is possible to take load off the console 14b of the second X-ray imaging system 2b because the console 14b does not need to have storage capacity for the absorptance data and the function of the arithmetic section.

In the above embodiment, the console 14a and the electronic cassette 13a are separate from each other. However, the console 14a may not be necessarily independent, but the electronic cassette 13a may have the function of the console 14a.

In the above embodiment, the required setup condition such as the tube current-time product is obtained from the optimal dose with the use of the practical experience or the dosimeter. However, a table representing the relation between the optimal dose and the setup condition may be prepared in advance in the storage device 22b. Note that, since the relation between the optimal dose and the setup condition varies from one type of radiation source to another, a plurality of tables corresponding to the number of types of radiation sources have to be prepared.

In this case, the first specification data 30a stores the setup condition such as the tube current-time product to be actually used by the X-ray source 10a, instead of the first optimal dose. Additionally, the first specification data 30a has an item of the type of X-ray source 10a. The second X-ray imaging system 2a extracts from the table the relation between the optimal dose and the setup condition in accordance with the type of X-ray source 10a stored in the first specification data 30a, and converts the setup condition of the first specification data 30a into the first optimal dose. A calculation procedure of the second optimal dose after this is the same as above.

To input the type of X-ray source 10b of the second X-ray imaging system 2b, the data entry window 55 of FIG. 6 is provided with a type entry box into which the radiographic technician enters the type of X-ray source 10b besides the second specification data 30b. Then, the setup condition such as the tube current-time product that corresponds to the inputted type of X-ray source 10b and the second optimal dose is extracted from the above table. The radiographic technician is notified of the extracted setup condition through the conversion result display window 65 of FIG. 8, instead of the second optimal dose. Accordingly, it is possible to easily and directly notify the radiographic technician of the setup condition such as the tube current-time product to be used by the X-ray source 10b, without measurement by the dosimeter.

The present invention is applicable to a radiation imaging system using any type of radiation, not only the X-rays but also γ-rays or the like.

Although the present invention has been fully described by the way of the preferred embodiment thereof with reference to the accompanying drawings, various changes and modifications will be apparent to those having skill in this field. Therefore, unless otherwise these changes and modifications depart from the scope of the present invention, they should be construed as included therein.

What is claimed is:

1. A radiation dose information sharing device for sharing radiation dose information between first and second radiation imaging systems, each of said first and second radiation imaging systems including a radiation source for emitting radiation and a detection panel for detecting a radiographic image from said radiation incident on an imaging plane, said radiation dose information sharing device comprising:
a data acquisition section for acquiring first specification data of said first radiation imaging system and second specification data of said second radiation imaging system;
a storage section for storing said first and second specification data acquired by said data acquisition section; and
an arithmetic section for converting a first optimal dose into a second optimal dose suitable for said second radiation imaging system based on said first and second specification data readout from said storage section, said first optimal dose being contained in said first specification data or calculated from said first specification data.

2. The radiation dose information sharing device according to claim 1 further comprising a display section for displaying a conversion result of said arithmetic section.

3. The radiation dose information sharing device according to claim 1, wherein said first and second specification data includes at least one of items of sensitivity of said detection panel, a distance between said radiation source and said imaging plane, and a type of an intermediate member disposed between said radiation source and said imaging plane.

4. The radiation dose information sharing device according to claim 3, wherein said first optimal dose varies from one imaging condition to another.

5. The radiation dose information sharing device according to claim 4, wherein
said storage section stores absorptance data representing absorptance of said radiation by said intermediate member; and
said arithmetic section calculates an increase/decrease ratio of a radiation dose on a basis of said item of said first and second specification data read out from said storage section according to a change from said first radiation imaging system to said second radiation imaging system, and calculates a total ratio being a product of said increase/decrease ratios of all said items, to obtain said second optimal dose by multiplying said first optimal dose by said total ratio.

6. The radiation dose information sharing device according to claim 5, wherein said absorptance data includes said absorptance of said radiation by said intermediate member, and said absorptance is measured independently from one imaging condition to another.

7. The radiation dose information sharing device according to claim 6, wherein said intermediate member includes at least one of a grid for removing scattered radiation, an AEC sensor for automatic exposure control, a detection panel holder provided in an imaging support, a mattress put on said imaging support, and an additional filter provided in said radiation source.

8. The radiation dose information sharing device according to claim 1, wherein said storage section stores tables each for representing a relation between a setup condition of said radiation source and an output radiation dose, independently from one type of said radiation source to another.

9. The radiation dose information sharing device according to claim 8, wherein
said second specification data includes a type of a second radiation source used in said second radiation imaging system; and
said arithmetic section outputs said setup condition of said second radiation source to obtain said second optimal dose by reference to said table that corresponds to said type of said second radiation source.

10. The radiation dose information sharing device according to claim 9, wherein
said first specification data includes a type of a first radiation source used in said first radiation imaging system and an optimal setup condition of said first radiation source; and
said arithmetic section retrieves an output radiation dose that corresponds to said optimal setup condition as said first optimal dose from said table that corresponds to said type of said first radiation source.

11. The radiation dose information sharing device according to claim 1, wherein
said arithmetic section calculates said second optimal dose of each imaging condition in advance;
said storage section stores said second optimal doses; and
upon input of said imaging condition, said second optimal dose corresponding to said inputted imaging condition is readout from said storage section.

12. The radiation dose information sharing device according to claim 1, wherein whenever an imaging condition is inputted, said arithmetic section calculates said second optimal dose that corresponds to said imaging condition.

13. The radiation dose information sharing device according to claim 5, wherein if a specification of a tube voltage of said radiation source is different between said first and second radiation imaging systems, said arithmetic section calculates said second optimal dose based on said absorptance data of said intermediate member corresponding to said tube voltage, and corrects a tube current or a radiation irradiation duration of said radiation source of said second radiation imaging system based on a ratio between said radiation dose of said first radiation imaging system and that of said second radiation imaging system in a state of having a same tube current-time product value.

14. The radiation dose information sharing device according to claim 1, further comprising:
a day counter for counting elapsed days from calibration of said radiation source of said second radiation imaging system and operation days of said detection panel of said second radiation imaging system, wherein
said storage section stores deterioration correction data that represents a relation of a dose correction rate of said radiation source relative to a number of said elapsed days and a relation of a dose correction rate relative to a number of said operation days; and
said arithmetic section corrects said second optimal dose based on said deterioration correction data read out from said storage section.

15. The radiation dose information sharing device according to claim 2, wherein said data acquisition section includes:
a GUI displayed on said display section, for accepting entry of said first and second specification data; and
an input device for entering said first and second specification data through said GUI.

16. The radiation dose information sharing device according to claim 1, wherein said data acquisition section is at least one of a network interface for receiving said first and second specification data transmitted over a network and a medium interface for importing said first and second specification data from a removable medium.

17. The radiation dose information sharing device according to claim 1, wherein said radiation dose information sharing device is provided in a console of said second radiation imaging system.

18. The radiation dose information sharing device according to claim 1, wherein said radiation dose information sharing device is independent from both said first and second radiation imaging systems.

19. The radiation dose information sharing device according to claim 18 further comprising:
a receiving section for receiving a sharing request from said second radiation imaging system; and
a sending section for sending said second optimal dose calculated by said arithmetic section to said second radiation imaging system.

20. A radiation dose information sharing method for sharing radiation dose information between first and second radiation imaging systems, each of said first and second radiation imaging systems including a radiation source for emitting radiation and a detection panel for detecting a radiographic image from said radiation incident on an imaging plane, said method comprising the steps of:
acquiring first specification data of said first radiation imaging system and second specification data of said second radiation imaging system;
storing said first and second specification data to a storage section; and
reading out said first and second specification data from said storage section, and converting a first optimal dose into a second optimal dose suitable for said second radiation imaging system based on said first and second specification data, said first optimal dose being contained in said first specification data or calculated from said first specification data.
